(19) United States
(12) Patent Application Publication
(10) Pub. No.: US 2023/0419368 A1
(43) Pub. Date: Dec. 28, 2023

(54) Thumbnail-Based N-Enforced Advertisement Frequency for Content Delivery Systems

(71) Applicant: Charter Communications Operating, LLC, St. Louis, MO (US)

(72) Inventors: Yassine MAALEJ, Aurora, CO (US); Sami S. MAKINEN, Littleton, CO (US)

(21) Appl. No.: 17/851,976

(22) Filed: Jun. 28, 2022

(51) Int. Cl. G06Q 30/02

(52) U.S. Cl. CPC G06Q 30/0272; G06Q 30/0243; G06Q 30/0261

(57) ABSTRACT

Systems, methods, and devices for dynamically including advertisements in content sent to a user device. A server computing device deployed in a service provider network may select an advertisement from one of a plurality of advertisement decision services (ADSs), generate a thumbnail of the selected advertisement, and compare the generated thumbnail to previously generated thumbnails to determine whether the selected advertisement was previously sent to the user device within a time period. The server may also determine whether the number of times that the selected advertisement has been sent to the user device within the time period exceeds a threshold value, and include the selected advertisement in the content sent the user device in response to determining that the number of times that the selected advertisement has been sent to the user device within the time period does not exceed the threshold value.

### BACKGROUND

Wired and wireless communication technologies have improved over the past several years, and service providers are now able offer their users a wide array of features and services over high-capacity cable, fiber, and/or wireless networks. As a result, the popularity and usage of Internet protocol (IP) based services (e.g., streaming multimedia, IP television, games, etc.) has grown rapidly, and the improvements in network throughput afforded by the high-capacity networks is being matched by the increase in user usage demands for IP services. By way of example, on-demand Internet streaming media services (e.g., Netflix®, Amazon Prime®, etc.) can now account for well over forty percent of the total Internet traffic at peak hours.

Due to these and other trends, there are now many content delivery systems (e.g., Video-On-Demand (VOD) systems, etc.) that allow a network operator (e.g., a cable company, a multiple-system operator (MSO), etc.) to stream content from a content provider to user devices. In these and other content delivery system, the content may include breaks or advertisement opportunities during which advertisements may be inserted into the content. This allows for the dynamic insertion of advertisements, which could be a significant source of revenue for a network operator and/or allow the network operator to provide its users with additional or more cost-effective services and solutions. Accordingly, new and improved systems for generating, displaying, and monitoring advertisements within content could be beneficial to advertisers, network operators, and users of their products and services.

### SUMMARY

The various aspects include methods of dynamically including advertisements in content sent to a user device, which may include selecting, by a processor in a server computing device deployed in a service provider network, an advertisement from one of a plurality of advertisement decision services (ADSs), generating a thumbnail of the selected advertisement, comparing the generated thumbnail to previously generated thumbnails to determine whether the selected advertisement was previously sent to the user device within a time period, determining the number of times that the selected advertisement has been sent to the user device within the time period in response to determining that the selected advertisement was previously sent to the user device, determining whether the number of times that the selected advertisement has been sent to the user device within the time period exceeds a threshold value, and including the selected advertisement in the content sent the user device in response to determining that the number of times that the selected advertisement has been sent to the user device within the time period does not exceed the threshold value.

In some aspects, the methods may further include including a different advertisement in the content sent the user device in response to determining that the number of times that the selected advertisement has been sent to the user device within the time period exceeds the threshold value.

In some aspects, the methods may further include forgoing including the selected advertisement in the content sent to the user device in response to determining that the number of times that the selected advertisement has been sent to the user device within the time period exceeds the threshold value.

In some aspects, the methods may further include determining the geolocation of the user device, and selecting an advertisement from one of a plurality of ADSs may include selecting the advertisement based on the determined geolocation of the user device.

In some aspects, selecting an advertisement from the one of a plurality of ADSs may include selecting a targeted advertisement from the one of a plurality of ADSs.

In some aspects, generating a thumbnail of the selected advertisement may include generating at least one thumbnail for an operator advertisement decision service (ADS) advertisement, and generating at least one thumbnail for a third-party ADS advertisement. In some aspects, comparing the generated thumbnail to the previously generated thumbnails to determine whether the selected advertisement was previously sent to the user device within the time period may include comparing the generated thumbnail to the previously generated thumbnails to determine whether the selected advertisement was previously sent to the user device within the time period independently of whether the selected advertisement originated locally in the service provider network or externally from a third-party system.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIGS. 1A and 1B are a system block diagrams of a content delivery system suitable for implementing some embodiments.

FIG. 1C is an activity diagram illustrating operations and communications between various components in the content delivery system suitable for dynamically including advertisements in content sent to a user device in accordance with some embodiments.

FIG. 2 is a process flow diagram illustrating an example dynamic advertising insertion method in accordance with some embodiments.

FIG. 3 is a process flow diagram illustrating a method of guaranteeing that a certain advertisement (or group of advertisements) is viewed by a specific user for a specific number of times over a specific time period in accordance with some embodiments.

FIG. 4 is a block diagram illustrating sample components of a user device suitable for use with the various embodiments.

FIG. 5 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, the various embodiments include methods, and computing devices configured to implement the methods, for guaranteeing that a certain advertisement (or group of advertisements) is viewed by a specific user (or target group) at a specific frequency and/or for a specific number of times over a specific time period on any or all of the user devices associated with that specific user.

The terms “user equipment (UE)” and “user device” may be used interchangeably herein to refer to any one or all of satellite or cable set top boxes, laptop computers, rack mounted computers, routers, cellular telephones, smart phones, internet of things (IOT) devices, personal or mobile multi-media players, personal data assistants (PDAs), customer-premises equipment (CPE), personal computers, tablet computers, smart books, palm-top computers, desk-top computers, wireless electronic mail receivers, multimedia Internet enabled cellular telephones, wireless gaming controllers, streaming media players (such as, ROKU™, Amazon Firestick®), smart televisions, digital video recorders (DVRs), modems, routers, network switches, residential gateways (RG), access nodes (AN), bridged residential gateway (BRG), fixed mobile convergence products, home networking adapters and Internet access gateways that enable consumers to access communications service providers' services and distribute them around their house via a local area network (LAN), and similar electronic devices which include a programmable processor and memory and circuitry for providing the functionality described herein.

The term “service provider network” and “network operator” may be may be used interchangeably herein to refer to any network suitable for providing consumers with access to the Internet or IP services over broadband connections. Service provider networks may encompass both wired and wireless networks/technologies. Examples of wired network technologies and networks that may be included within a service provider network include cable networks, fiber optic networks, hybrid-fiber-cable networks, Ethernet, local area networks (LAN), metropolitan area networks (MAN), wide area networks (WAN), networks that implement the data over cable service interface specification (DOCSIS), networks that utilize asymmetric digital subscriber line (ADSL) technologies, etc. Examples of wireless network technologies and networks that may be included within a service provider network include third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), high-speed downlink packet access (HSDPA), 3GSM, general packet radio service (GPRS), code division multiple access (CDMA) systems (e.g., cdmaOne, CDMA2000™), enhanced data rates for GSM evolution (EDGE), advanced mobile phone system (AMPS), digital AMPS (IS-135/TDMA), evolution-data optimized (EV-DO), digital enhanced cordless telecommunications (DECT), Worldwide Interoperability for Microwave Access (WIMAX), wireless local area network (WLAN), Wi-Fi Protected Access I & II (WPA, WPA2), Bluetooth®, land mobile radio (LMR), and integrated digital enhanced network (iden). Each of these wired and wireless technologies involves, for example, the transmission and reception of data, signaling and/or content messages.

Any references to terminology and/or technical details related to an individual wired or wireless communications standard or technology are for illustrative purposes only, and not intended to limit the scope of the claims to a particular communication system or technology unless specifically recited in the claim language.

Various examples of sessions are discussed herein, such as VOD sessions, etc. The discussions of specific types of sessions are provided merely as examples to better illustrate the aspects of the various embodiments and are not intended to limit the various embodiments in any way. Other types of sessions may be used with the various embodiments, and the other types of sessions may be substituted in the various examples without departing from the spirit or scope of the invention.

Generally, advertisement systems obtain advertisements from multiple different sources. For example, an advertisement system may include an advertising router that receives (sometimes referred to as pulls or pulling) a percentage of the advertisements that are to be displayed to the user (often a minority percentage) from a database of advertisements owned by the network operator. The advertisement system may receive the remaining percentage of advertisements to be displayed (often a majority percentage) from third party advertising servers over which the network operator has little or no control. Often, the advertisement system obtains the same advertisement (or an advertisement from the same advertisement campaign) from multiple different sources. For these and other reasons (e.g., the prohibitive resource requirements for comparing full length advertisement videos, etc.), existing and conventional advertisement systems generally remain unaware of number of times that a specific advertisement, or an advertisement from the same advertisement campaign, has been displayed on the user device.

Many conventional advertisement systems send or broadcast advertisements based on geographic location. For example, a conventional advertisement server may advertise that a store is having a Black Friday sale to all of the users that are within the geographic vicinity of the store. A conventional advertisement server may also send targeted advertisements. For example, an advertisement server may select an advertisement from a database of available advertisements based on a user's demographics (or usage history, spending history, etc.), and send the selected advertisement to that user. In instances in which the user actually receives and views the targeted content over a threshold number of displayed instances, these targeted and/or location-based advertising solutions may be highly effective advertising solutions. Yet, existing and conventional advertisement system solutions do not ensure that a specific advertisement (or a specific group of advertisements) is viewed by a specific user a specific number of times over a specific time period across multiple user devices (TVs, tables, VR glasses, etc.). As a result, it is challenging for advertisers to collect accurate metrics and/or accurately determine number of times that a specific advertisement (or an advertisement from the same advertisement campaign) has been sent and displayed to the user on the user's user device. For the same or similar reasons, it is also challenging for network operators to dynamically adjust the operations of their advertisement systems to ensure that the user views an advertisement a desired number of times within a given time period.

The various embodiments overcome these and other deficiencies of existing and related advertisement system solutions by, for example, using a thumbnail algorithm to generate consistent thumbnails of the advertisements that are to be sent to the user devices, and using the generated thumbnails to determine the number of times that the advertisement has been sent to the user device. The embodiments may also include components that are configured to accurately determine or approximate the geolocation of the user device (e.g., through 5G connectivity, location management function (LMF), radio frequency, and/or other similar location based technologies), receive or intelligently select an advertisement or a group of advertisements that are relevant to the user (e.g., based on purchase history, demographics, current location of the user device, proximity or a store or vendor, etc.) from one or more independent advertisement servers, determine the number and type(s) of user device(s) associated with the user, determine the devices currently in use by the user, format the received or selected advertisements based on the determined device type(s) of the devices currently in use, determine the number of times that the selected advertisement or a group of advertisements should be displayed to the user, determine the frequency (e.g., per day, per type of content, per location, per type of device etc.) in which the selected advertisement should be displayed (e.g., once every 5 minutes, etc.) to the user, determine the number of times that the advertisement has been displayed to the user within a time period, and/or cause the currently used device(s) to render the advertisements in the correct format at the determined frequency and/or for the determined number of times.

In some embodiments, the components may also be configured to determine whether each rendered advertisement was actually viewed by the user (e.g., presented to the eyes of the user) and/or the frequency in which the rendered advertisements are actually being viewed by the user. The component may continue to cause the device(s) to render the advertisements and/or dynamically adjust the frequency in which the advertisements are rendered on the user device(s) until it determines that the advertisement(s) have been displayed and viewed by the end user for the determined number of times.

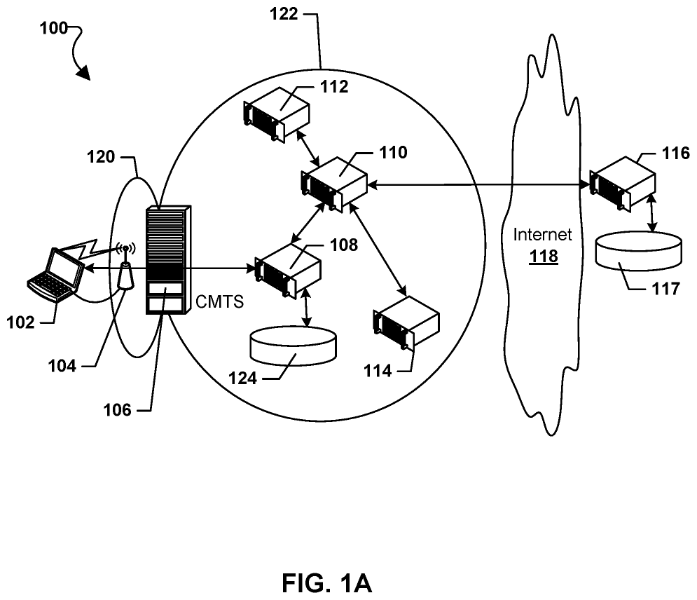

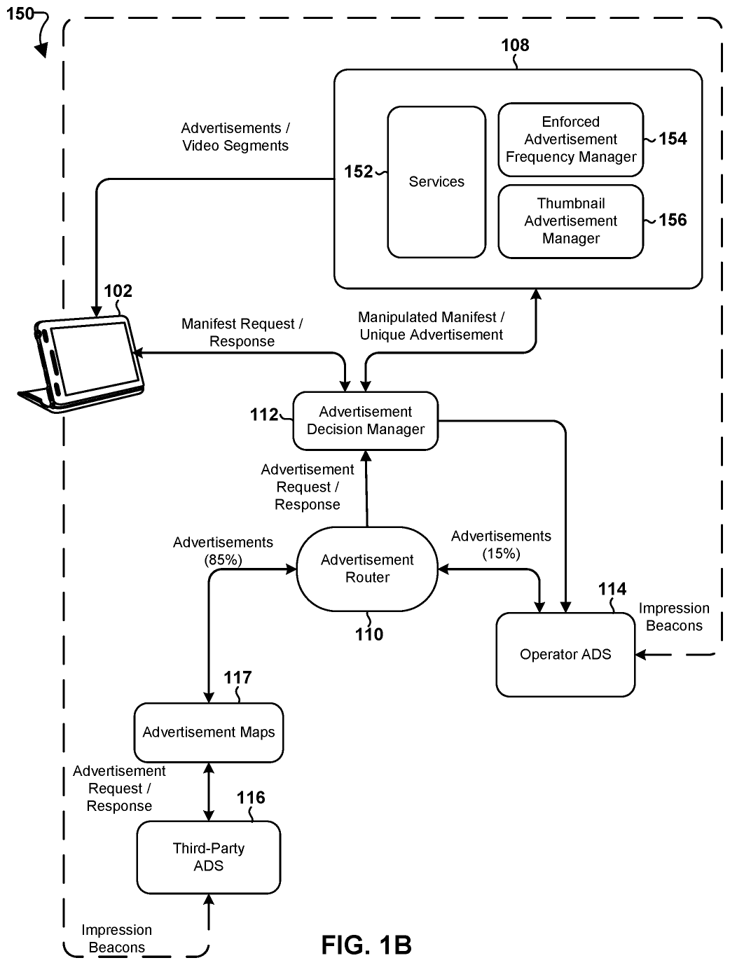

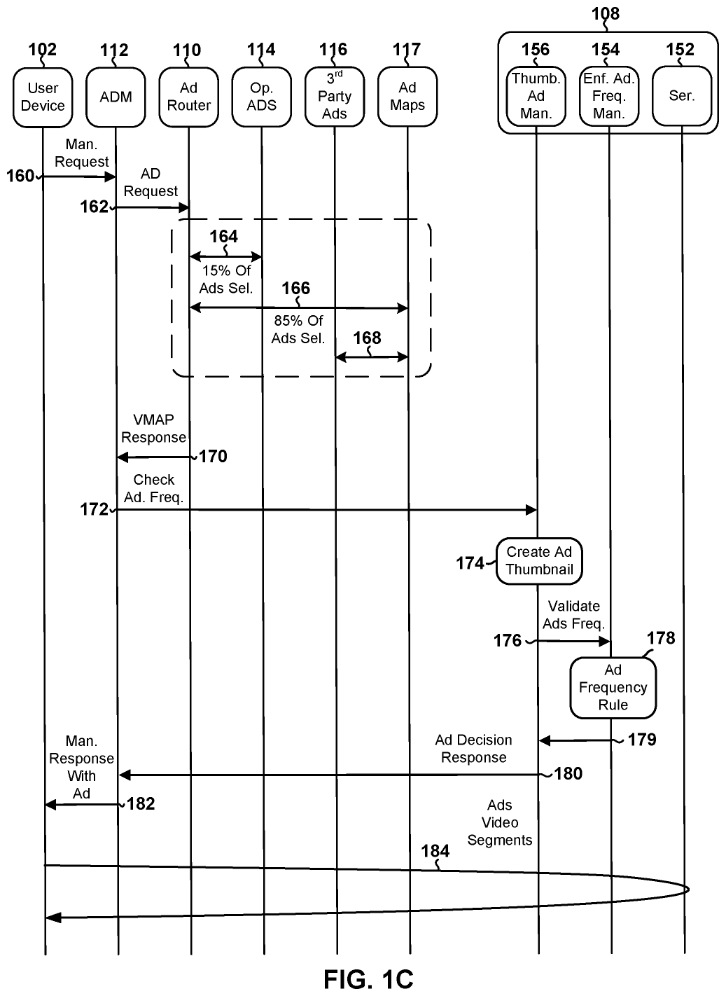

FIGS. 1A-1C illustrate example components and operations in content delivery systems 100, 150 that are suitable for use with various embodiments. In the examples illustrated in FIGS. 1A-1C, the system 100 includes a user device 102, customer-premises equipment (CPE) 104, cable modem termination system (CMTS) 106, a video on demand (VOD) server 108, an advertisement router server 110, advertising decision manager (ADM) 112, an operator advertisement decision service (ADS) 114, a third-party ADS 116, and an advertisement map 117 component.

With reference to FIG. 1A, the user device 102 may exchange data via one or more wired or wireless connections with the CPE 104. The CPE 104 may include a cable modem, digital subscriber line modem, router, switch, firewall, packet filter, wireless access point, pod (e.g., in a local mesh network, etc.) and/or a residential gateway that provide network connectivity to home or small office network. The CPE 104 may be configured to allow user devices 102 on a local area network (LAN) to connect to a wide area network (WAN) and ultimately the Internet 118.

In the example illustrated in FIG. 1A, the CPE 104 is connected to the CMTS 106 via a hybrid fiber-coaxial (HFC) network 120. The CMTS 106 may enable data to be exchanged between the user device 102, CPE 104, and components in the service provider network 122, such as the VOD server 108, the advertisement router server 110, the advertising decision manager 112, the operator ADS 114, etc. These components 108-114 may exchange data with one another via connections within the service provider network 122 and may exchange data with devices outside the service provider network 122, such as third-party ADS 116 via the service provider network's connections to the Internet 118.

The VOD server 108 may provide VOD content from the network operator or third-party content providers to the user device 102. For example, the VOD server 108 may access a content store 124 to provision selected VOD content to the user for a VOD session. The VOD content may include breaks, such as pre-roll, mid-roll, and/or post-roll breaks, in which advertisements (or advertisements) may be inserted. In some embodiments, the breaks in the VOD content may be defined by an advertisement map 117 associated with the VOD content.

The VOD server 108 may also send an advertisement placement request for a VOD session to the advertisement router server 110. The advertisement placement request may identify attributes of the VOD session, such as the VOD content to be streamed for the VOD session, the network over which the VOD content may be streamed, the third-party that is responsible for providing the content, the advertisement map for the VOD session, etc. The advertisement placement request may also identify attributes regarding the advertisement breaks in the VOD session, such as the opportunity types (e.g., pre-roll, mid-roll, and/or post-roll, etc.), break numbers, third-party id, network id, etc.

The advertisement router server 110 may receive and use the advertisement placement request to determine advertisements for a VOD session. As part of these operations, the advertisement router server 110 may send advertisement request messages to the operator ADS 114 and/or the third-party ADS 116 to receive indications of the advertisements to select for a VOD session. For example, the third-party ADS 116 may indicate selected advertisements for the third-party inventory to the advertisement router server 110, and the operator ADS 114 may indicate selected advertisements for the operator inventory (i.e., owned inventory) to the advertisement router server 110. The party provisioning the VOD content may control a certain percentage of the advertising inventory (e.g., 85% of the advertising inventory for the VOD session is third-party inventory, etc.) and the network operator may control a certain percentage of advertising inventory (e.g., 15% of the advertising inventory for the VOD session is operator/owned inventory, etc.).

The advertisement router server 110 may use the determined advertisements to generate an advertisement list that identifies advertisements to be inserted into the breaks, and send the generated advertisement list to the VOD server 108. The VOD server 108 may receive and use the advertisement list to insert the selected advertisements into the VOD stream so that the user device may display the selected advertisements for the end user to view while watching the VOD content on the user device 102.

In some embodiments, the advertisement router server 110 may also request inventory rules from an inventory optimization server associated with the advertising decision manager 112 and/or communicate advertisement metrics (e.g., harvest metrics, etc.) to the inventory optimization server. The inventory optimization server may be configured to generate advertisement inventory rules. The advertisement inventory rules may be based on one or more inventory handling definitions, which may be provided to the inventory optimization server by third parties and/or network operators. The advertisement inventory rules may include rights definitions for the advertisement inventory to direct how one or more ADSs may assign advertisements. The advertisement inventory rules may also include various limits on how advertisement inventory may be handled, such as opportunity type limits, advertisement type limits, third-party limits, network limits, session limits, time period limits, break limits, content type limits, combinations of those limits (e.g., limits by opportunity type and advertisement type, etc.), and/or any other type limits applicable to VOD advertisement placement.

In the examples illustrated in FIGS. 1B and 1C, the VOD server 108 includes a services 152 component, an enforced advertisement frequency manager 154 component, and a thumbnail advertisement manager 156 component, which may operate to guarantee that a certain advertisement (or group of advertisements) is viewed by a specific user (or target group) at a specific frequency and/or for a specific number of times over a specific time period on any or all of the user devices 102 associated with that specific user in accordance with various embodiments.

The thumbnail advertisement manager 156 component may be configured to apply a thumbnail algorithm to the advertisements to generate consistent thumbnails of the advertisements, compare the generated thumbnails to thumbnails of previously displayed advertisements, and use the results of the comparison to determine whether the advertisement has previously been displayed to the user within a time period and/or whether the advertisement is a unique advertisement for the time period. The enforced advertisement frequency manager 154 component may be configured to keep track of the frequency or number of times that each advertisement has been and/or should be displayed to the user on any or all of the user devices 102 associated with that specific user. The enforced advertisement frequency manager 154 component may also prevent the same advertisement from being sent to the user device 102 too frequently or more than the determined number of times for that time period. The services 152 component may include hosting services, an encoder, a packager, a distributor, etc.

With reference to FIGS. 1B and 1C, in operation 160 the user device 102 may generate and send a manifest request message to the advertising decision manager (ADM) 112. In operation 162, the ADM 112 may receive and use the manifest request message to generate and send an advertising decision request message (or the advertisement placement request message) to the advertisement router server 110. The advertisement router server 110 may receive and use the advertising decision request message (or the advertisement placement request message) to determine advertisements (e.g., for a VOD session, etc.).

In operation 164, the advertisement router server 110 may send an advertisement request message to the operator ADS 114. In response, the operator ADS 114 may indicate selected advertisements for the operator inventory (i.e., owned inventory) to the advertisement router server 110. In the example illustrated in FIG. 1C, 15% of the advertising inventory is operator/owned inventory.

In operations 166 and 168, the advertisement router server 110 may send an advertisement request message to the advertisement map 117 component, the advertisement map 117 component may request and receive advertisement information from the third-party ADS 116, and the advertisement map 117 component may send indications of the advertisements (i.e., third-party inventory) to select to the advertisement router server 110. In the example illustrated in FIG. 1C, 85% of the advertising inventory is third-party inventory.

In operation 170, the advertisement router server 110 may use the received indications of the advertisements to generate and send a Video Multiple Ad Playlists (VMAP) response message to the ADM 112.

In operation 172, the ADM 112 may use the information included in the VMAP response message to generate and send a check advertisement frequency message to the thumbnail advertisement manager 156 component of the VOD server 108.

In operation block 174, the thumbnail advertisement manager 156 component apply a thumbnail algorithm to the advertisements to generate consistent thumbnails of the advertisements and compare the generated thumbnails to thumbnails of previously displayed advertisements.

In operation 176, the thumbnail advertisement manager 156 component may generate and send a validate advertisement frequency message (e.g., that includes a result of the comparison, etc.) to the enforced advertisement frequency manager 154 component of the VOD server 108. As mentioned above, the enforced advertisement frequency manager 154 component may be configured to keep track of the frequency or number of times that each advertisement has been and/or should be displayed to the user on any or all of the user devices 102 associated with that specific user. The enforced advertisement frequency manager 154 component may also prevent the same advertisement from being sent to the user device 102 too frequently or more than the determined number of times for that time period.

In operation block 178, the enforced advertisement frequency manager 154 component may request, receive, generate, enforce, and/or validate advertisement frequency rules based on the information included in the validate advertisement frequency message. In some embodiments, as part of these operations, the enforced advertisement frequency manager 154 use the information received from the thumbnail advertisement manager 156 component (e.g., results of the comparison, etc.) to determine whether the advertisement has previously been displayed to the user within a time period and/or whether the advertisement is a unique advertisement for the time period.

In operation 179, the enforced advertisement frequency manager 154 component may send information to the thumbnail advertisement manager 156 component that indicates (or which allows the thumbnail advertisement manager 156 to determine) whether the advertisement has previously been displayed to the user within a time period and/or whether the advertisement is a unique advertisement for the time period.

In operation 180, the thumbnail advertisement manager 156 component may generate and send an advertisement decision response message to the ADM 112.

In operation 182, the ADM 112 may generate and send a manifest response message with advertisements to the user device 102.

In operation 184, the user device 102 may request and receive advertisement video segments from the services 152 component of the VOD server 108.

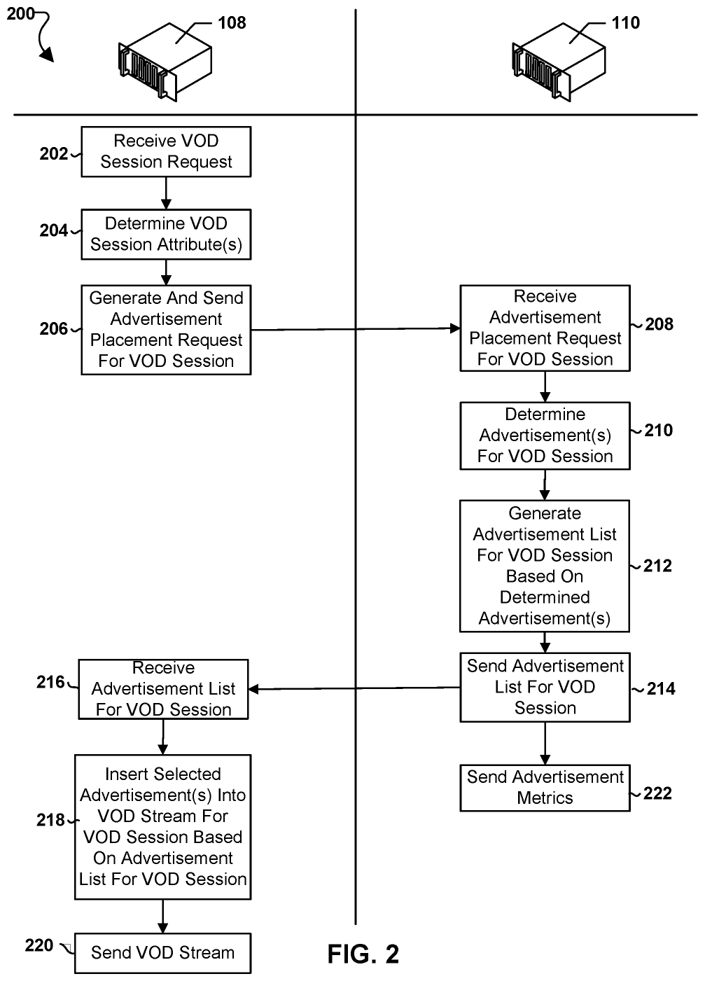

FIG. 2 is a process flow diagram illustrating an example dynamic advertisement insertion method 200 in accordance with some embodiments. The operations of method 200 may be performed by one or more processors in a VOD server 108 and/or advertisement router server 110.

In block 202, the VOD server 108 may receive a VOD session request message from a user device 102 associated with a user desiring to view VOD content. The VOD session request message may identify the VOD content to be viewed, the network used by the computing device to stream the VOD session, etc. In block 204, the VOD server 108 may determine one or more VOD session attributes. The VOD session attributes may be parameters of the VOD session, such as the VOD content identifier, an identifier of the programmer providing the VOD content, an identifier of the network used by the computing device to stream the VOD session, an advertisement map for the VOD session, etc. In block 206, the VOD server 108 may generate and send an advertisement placement request for the VOD session to the advertisement router server 110. The advertisement placement request may indicate one or more of the determined VOD session attributes.

In block 208, the advertisement router server 110 may receive the advertisement placement request for the VOD session. In block 210, the advertisement router server 110 may determine one or more advertisements for the VOD session. In block 212, the advertisement router server 110 may generate an advertisement list for the VOD session based on the determined one or more advertisements. The advertisement list may identify the advertisement IDs of advertisements to be inserted into the breaks of the VOD session. In block 214, the advertisement router server 110 may send the advertisement list for the VOD session to the VOD server 108.

In some embodiments, in block 222, the advertisement router server 110 may send advertisement metrics, such as harvest metrics, to an inventory optimization server. Advertisement metrics, such as harvest metrics, may include the programmer, network, date, time, session, break number, break sequence, and placed ad identifier (when placement occurs) for each unused programmer ad inventory (i.e., transferred VOD ad placement opportunities that the programmer did not fill).

In block 216, the VOD server 108 may receive the advertisement list for the VOD session. The advertisement list may identify advertisements to be inserted into the breaks from the content store available to the VOD server. In block 218, the VOD server 108 may insert the selected advertisement into the VOD stream for the session based on the advertisement list for the VOD session. In block 220, the VOD server 108 may send the VOD stream. In this manner, the user may view the selected advertisement while watching the VOD content on any or all of the user devices 102 associated with that specific user.

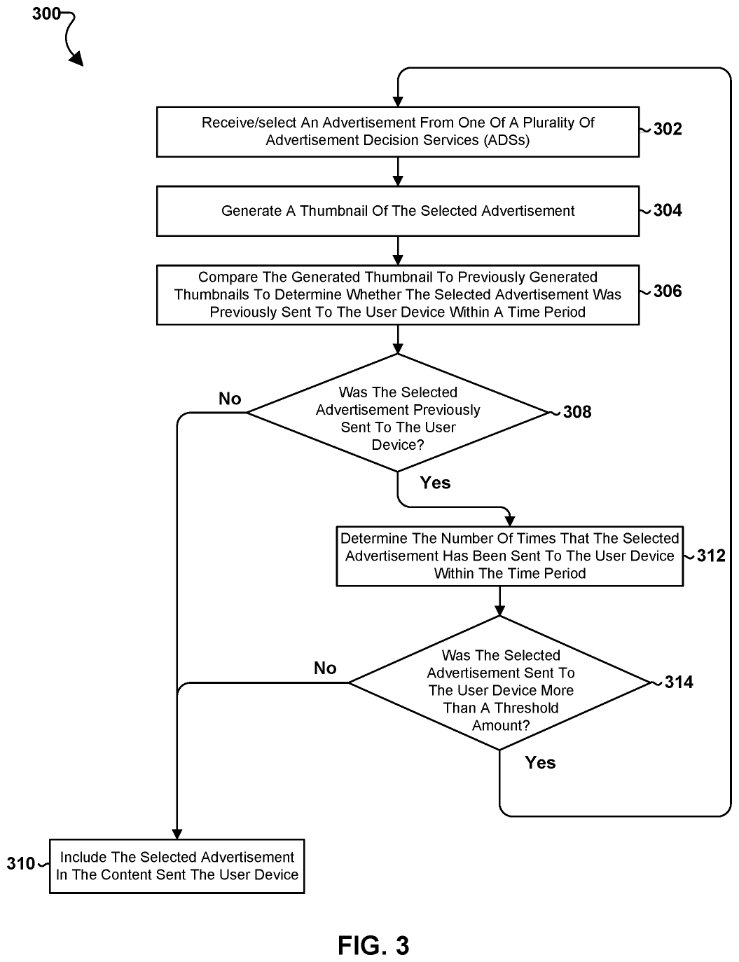

FIG. 3 illustrates a method 300 of dynamically including advertisements in content sent to a user device in accordance with the embodiments. Method 300 may be performed by one or more processors in one or more server computing devices deployed in a service provider network.

In block 302, the processor may receive or select an advertisement from one of a plurality of advertisement decision services (ADSs). In some embodiments, the processor may select a targeted advertisement from the one of a plurality of ADSs in block 302. In some embodiments, the processor may determine the geolocation of the user device, and select the advertisement based on the determined geolocation of the user device. For example, when a connected device is in a specific zip code or location (e.g., airport terminal), the system may attempt to place ads with as much unique frequency to users as possible (e.g., try to reach as much unique travelers as possible with specific restaurants or drinks offered by vending machines, etc.).

In block 304, the processor may generate a thumbnail of the selected advertisement. In some embodiments, the processor may be configured to implement or use a deterministic thumbnail picker to generate the thumbnail in block 304. The deterministic thumbnail picker may guarantee the generation of same thumbnails of the same video (e.g., select frames on 10%, 30%, 50%, 70%, 90% of the video, etc.). In some embodiments, generating the thumbnail in block 304 may include generating at least one thumbnail for an operator advertisement decision service (ADS) advertisement and generating at least one thumbnail for a third-party ADS advertisement.

In block 306, the processor may compare the generated thumbnail to previously generated thumbnails to determine whether the selected advertisement was previously sent to the user device within a time period. In some embodiments, the processor may perform these operations independently of whether the selected advertisement originated locally in the service provider network (e.g., is operator ADS advertisement, etc.) or externally from a third-party system (e.g., is third-party ADS advertisement, etc.).

In determination block 308, the processor may use the comparison results generated in block 306 to determine whether the selected advertisement was previously sent to the user device within the time period. In response to determining that the selected advertisement was not previously sent to the user device within the time period (i.e., determination block 308=“No”), in block 310 the processor may include the selected/received advertisement in the content (e.g., video stream) that is sent to the user device. In response to determining that the selected advertisement was previously sent to the user device within the time period (i.e., determination block 308=“Yes”), in block 312 the processor may determine the number of times that the selected advertisement has been sent to the user device within the time period.

In determination block 314, the processor may determine whether the number of times that the selected advertisement has been sent to the user device within the time period exceeds a threshold value. In response to determining that the number of times that the selected advertisement has been sent to the user device within the time period does not exceed the threshold value (i.e., determination block 314=“No”), in block 310 the processor may include the selected/received advertisement in the content (e.g., video stream) that is sent to the user device. In response to determining that the number of times that the selected advertisement has been sent to the user device within the time period exceeds the threshold value (i.e., determination block 314=“Yes”), the processor may forgo including the selected advertisement in the content sent to the user device and/or repeat the operations of method 300 to include a different advertisement in the content sent the user device.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 200 and 300 may be substituted for or combined with one or more operations of the methods 200 and 300 and vice versa.

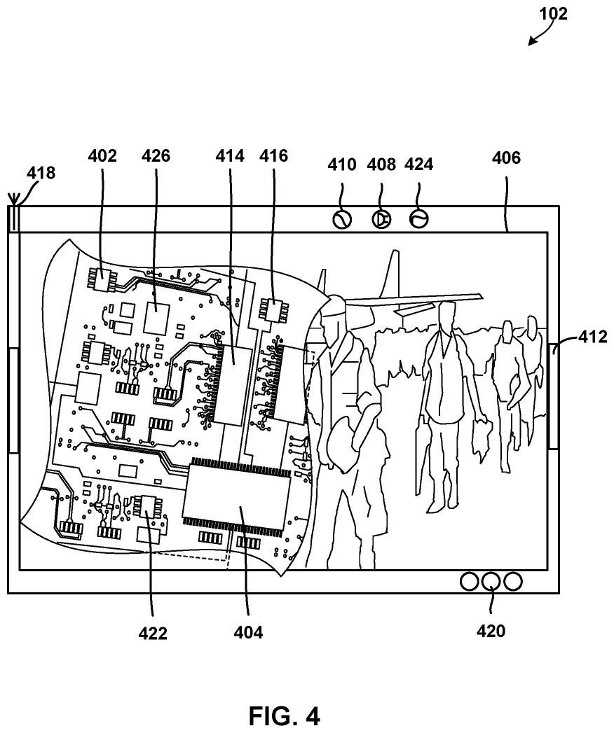

FIG. 4 illustrates sample components of a user device 102, in the form of a tablet computing device, that may be configured in accordance with various embodiments. Specifically, FIG. 4 illustrates that the user device 102 may include a processor 402 coupled to internal memory 404, an electronic display 406, a microphone 408, a camera 410, sensors 426, and/or to a speaker 412. The user device 102 may further include user interface 420 elements (e.g., buttons, icons, etc.) for receiving user inputs, which may be hard key buttons, soft key buttons, touch keys, or any input means suitable for receiving a user input.

The sensors 426 may include one or more sensors configured to detect motion, gestures (e.g., hand movements), eye movements, and/or other user actions, which when recognized by the user device 102, may cause the user device 102 to execute a specific command or operation. The sensors 426 may also include one or more sensors for scanning/collecting information from the user's environment (e.g., room, etc.), geo-spatial positioning sensors (e.g., GPS transceiver, etc.), distance measuring sensors (e.g., a laser, sonic range finder, etc.), orientation sensors (e.g., up, down, level, etc.), etc. The sensors 426 may further include an eye tracking component configured to detect eye movements or the presence or the location of the user's eye (e.g., via the camera 410) relative to the user device 102 or electronic display 406.

The user device 102 may include communications circuitry 414 coupled to the processor 402 for establishing data connections with a network, such as a local area network coupled to servers or computers of a service provider network. Additionally, the user device 102 may include a transceiver 416, a wireless radio 422 (e.g., Bluetooth® radio, WiFi radio, etc.), and/or an antenna 418 for sending and receiving electromagnetic radiation and/or connecting to a wireless data link.

The processor 402 and memory 404 may be configured to receive audio-video content from a network server (e.g., a content server, an application server, etc.) and process and present the received audio-video content on the electronic display 406 and speaker 412. The user device 102 may communicate with the network server via a direct communication link (e.g., wireless data link, etc.), through a central server, via short-range radio technologies (e.g., Bluetooth®, WiFi, etc.), via peer-to-peer connections, or via any other known communication technologies.

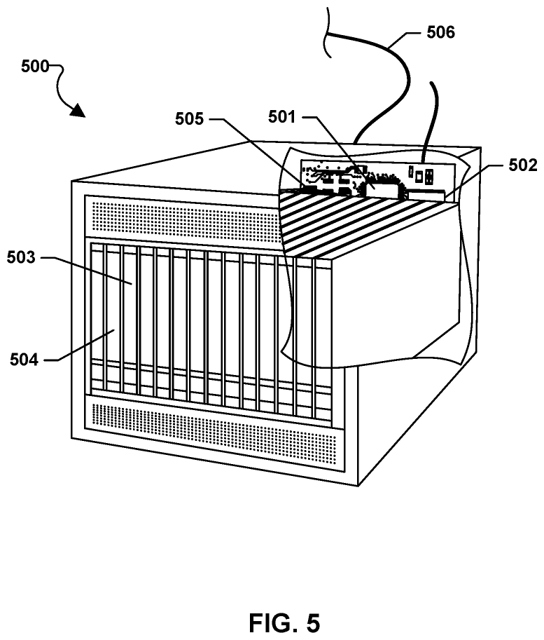

Various embodiments may be implemented on any of a variety of commercially available server devices, such as the server device 500 illustrated in FIG. 5. Such a server device 500 may include a processor 501 coupled to volatile memory 502 and a large capacity nonvolatile memory, such as a disk drive 503. The server device 500 may also include a floppy disc drive, compact disc (CD) or DVD disc drive 504 coupled to the processor 501. The server device 500 may also include network access ports 506 coupled to the processor 501 for establishing data connections with a network connection circuit 505 and a communication network (e.g., IP network) coupled to other communication system network elements.

The processors 411, 501 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 411, 501. The processors 411, 501 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 411, 501 including internal memory or removable memory plugged into the device and memory within the processors 411, 501 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A method of dynamically including advertisements in content sent to a user device, comprising:
selecting, by a processor in a server computing device deployed in a service provider network, an advertisement from one of a plurality of advertisement decision services (ADSs);
generating a thumbnail of the selected advertisement;
determining whether the selected advertisement was previously sent to the user device within a time period based on a result of comparing the generated thumbnail of the selected advertisement to previously generated thumbnails of the selected advertisement;
determining a number of times that the selected advertisement has been sent to the user device within the time period in response to determining that the selected advertisement was previously sent to the user device;
determining whether the number of times that the selected advertisement has been sent to the user device within the time period exceeds a threshold value; and
including the selected advertisement in the content sent to the user device in response to determining that the number of times that the selected advertisement has been sent to the user device within the time period does not exceed the threshold value.

2. The method of claim 1, further comprising including a different advertisement in the content sent to the user device in response to determining that the number of times that the selected advertisement has been sent to the user device within the time period exceeds the threshold value.

3. The method of claim 1, further comprising forgoing including the selected advertisement in the content sent to the user device in response to determining that the number of times that the selected advertisement has been sent to the user device within the time period exceeds the threshold value.

4. The method of claim 1, further comprising determining a geolocation of the user device, wherein selecting an advertisement from one of a plurality of ADSs comprises selecting the advertisement based on the determined geolocation of the user device.

5. The method of claim 1, wherein selecting an advertisement from the one of a plurality of ADSs comprises selecting a targeted advertisement from the one of a plurality of ADSs.

6. The method of claim 1, wherein generating a thumbnail of the selected advertisement comprises:
generating at least one thumbnail for an operator advertisement decision service (ADS) advertisement; and
generating at least one thumbnail for a third-party ADS advertisement.

7. The method of claim 6, wherein comparing the generated thumbnail to the previously generated thumbnails to determine whether the selected advertisement was previously sent to the user device within the time period comprises comparing the generated thumbnail to the previously generated thumbnails to determine whether the selected advertisement was previously sent to the user device within the time period independently of whether the selected advertisement originated locally in the service provider network or externally from a third-party system.

8. A server computing device, comprising:
a processor configured with processor-executable software instructions to:
select an advertisement from one of a plurality of advertisement decision services (ADSs);
generate a thumbnail of the selected advertisement;
determine whether the selected advertisement was previously sent to a user device within a time period based on a result of comparing the generated thumbnail to previously generated thumbnails;
determine a number of times that the selected advertisement has been sent to the user device within the time period in response to determining that the selected advertisement was previously sent to the user device;
determine whether the number of times that the selected advertisement has been sent to the user device within the time period exceeds a threshold value; and
include the selected advertisement in content sent to the user device in response to determining that the number of times that the selected advertisement has been sent to the user device within the time period does not exceed the threshold value.

9. The server computing device of claim 8, wherein the processor is further configured with processor-executable software instructions to include a different advertisement in the content sent to the user device in response to determining that the number of times that the selected advertisement has been sent to the user device within the time period exceeds the threshold value.

10. The server computing device of claim 8, wherein the processor is further configured with processor-executable software instructions to forgo including the selected advertisement in the content sent to the user device in response to determining that the number of times that the selected advertisement has been sent to the user device within the time period exceeds the threshold value.

11. The server computing device of claim 8, wherein:
the processor is further configured with processor-executable software instructions to determine a geolocation of the user device; and
the processor is configured with processor-executable software instructions to select an advertisement from one of a plurality of ADSs by selecting the advertisement based on the determined geolocation of the user device.

12. The server computing device of claim 8, wherein the processor is configured with processor-executable software instructions to select an advertisement from the one of a plurality of ADSs by selecting a targeted advertisement from the one of a plurality of ADSs.

13. The server computing device of claim 8, wherein the processor is configured with processor-executable software instructions to generate a thumbnail of the selected advertisement by:
generating at least one thumbnail for an operator advertisement decision service (ADS) advertisement; and
generating at least one thumbnail for a third-party ADS advertisement.

14. The server computing device of claim 13, wherein the processor is configured with processor-executable software instructions to compare the generated thumbnail to the previously generated thumbnails to determine whether the selected advertisement was previously sent to the user device within the time period by comparing the generated thumbnail to the previously generated thumbnails to determine whether the selected advertisement was previously sent to the user device within the time period independently of whether the selected advertisement originated locally in the service provider network or externally from a third-party system.

15. A non-transitory computer readable storage medium having stored thereon processor-executable software instructions configured to cause a processor in a computing device deployed in a service provider network to perform operations for dynamically including advertisements in content sent to a user device, the operations comprising:
selecting an advertisement from one of a plurality of advertisement decision services (ADSs);
generating a thumbnail of the selected advertisement;
determining whether the selected advertisement was previously sent to the user device within a time period base on a result of comparing the generated thumbnail to previously generated thumbnails;
determining the number of times that the selected advertisement has been sent to the user device within the time period in response to determining that the selected advertisement was previously sent to the user device;
determining whether a number of times that the selected advertisement has been sent to the user device within the time period exceeds a threshold value; and
including the selected advertisement in the content sent to the user device in response to determining that the number of times that the selected advertisement has been sent to the user device within the time period does not exceed the threshold value.

16. The non-transitory computer readable storage medium of claim 15, wherein the stored processor-executable software instructions are configured to cause the processor to perform operations further comprising including a different advertisement in the content sent to the user device in response to determining that the number of times that the selected advertisement has been sent to the user device within the time period exceeds the threshold value.

17. The non-transitory computer readable storage medium of claim 15, wherein the stored processor-executable software instructions are configured to cause the processor to perform operations further comprising forgoing including the selected advertisement in the content sent to the user device in response to determining that the number of times that the selected advertisement has been sent to the user device within the time period exceeds the threshold value.

18. The non-transitory computer readable storage medium of claim 15, wherein the stored processor-executable software instructions are configured to cause the processor to perform operations further comprising determining a geolocation of the user device, wherein selecting an advertisement from one of a plurality of ADSs comprises selecting the advertisement based on the determined geolocation of the user device.

19. The non-transitory computer readable storage medium of claim 15, wherein the stored processor-executable software instructions are configured to cause the processor to perform operations such that selecting an advertisement from the one of a plurality of ADSs comprises selecting a targeted advertisement from the one of a plurality of ADSs.

20. The non-transitory computer readable storage medium of claim 15, wherein the stored processor-executable software instructions are configured to cause the processor to perform operations such that:
generating a thumbnail of the selected advertisement comprises:
generating at least one thumbnail for an operator advertisement decision service (ADS) advertisement; and
generating at least one thumbnail for a third-party ADS advertisement.

21. The non-transitory computer readable storage medium of claim 20, wherein the stored processor-executable software instructions are configured to cause the processor to perform operations such that comparing the generated thumbnail to the previously generated thumbnails to determine whether the selected advertisement was previously sent to the user device within the time period comprises comparing the generated thumbnail to the previously generated thumbnails to determine whether the selected advertisement was previously sent to the user device within the time period independently of whether the selected advertisement originated locally in the service provider network or externally from a third-party system.
